SEQUENCE LISTING (1 sequence)

SEQ ID NO: 1 - DNA, 18 bp, Artificial Sequence
  Synthesized Probe
actggccgtcgttttaca

(19) United States
(12) Patent Application Publication
(10) Pub. No.: US 2011/0237463 A1
(43) Pub. Date: Sep. 29, 2011

(54) APPARATUS FOR APPLYING SOLUTION

(75) Inventors: YOSHIMASA ARAKI, YOKOHAMA-SHI (JP); TOHRU ISHIBASHI, TOKYO (JP)

(73) Assignee: CANON KABUSHIKI KAISHA, Tokyo (JP)

(21) Appl. No.: 13/156,706

(22) Filed: Jun. 9, 2011

Related U.S. Application Data
(62) Division of application No. 11/517,405, filed on Sep. 8, 2006.

(30) Foreign Application Priority Data
Sep. 15, 2005 (JP) 2005-268711

(51) Int. Cl. C40B 50/14

(52) U.S. Cl. 506/30

(57) ABSTRACT

An apparatus for applying a solution to be used for manufacturing DNA chips is provided in a holding member with a sensor for monitoring a substrate temperature, a temperature adjusting section for controlling the substrate temperature, and a control section for feeding back a control temperature, by using the monitored temperature, to the temperature adjusting section for controlling the substrate temperature, wherein the substrate temperature is controlled to such a level as will accelerate the reaction between the substrate and probes in the sample solution.

### BACKGROUND OF THE INVENTION

1. Field of the Invention

The present invention relates to an apparatus for applying sample solution onto substrates.

2. Description of the Related Art

One of the methods of recording on a recording medium is the ink jet system by which liquid droplets are ejected from a nozzle provided on the printing head. Best known applications of this system are printers for printing color images on paper. However, because of its advantage of permitting pinpoint targeting of minute liquid droplets, the ink jet system is applied not only to printers but also to manufacturing apparatuses for probe arrays, consisting of biological macromolecules fixed on substrates, typically including DNA chips. The ink jet system include such versions as the bubble jet system utilizing the boiling generated by the application of heat and the piezo-jet system using mechanical modification of piezo elements.

For the manufacture of probe arrays mentioned above, spotting apparatuses which spot sample solutions onto substrates with pins are also used besides the ink jet system.

As an example of DNA chip manufacturing, a conventional ejecting apparatus (of the bubble jet system) will be described below. FIG. 8 shows a perspective view of the ejecting apparatus.

A Y axis stage 81 and guide rails 82 are fixed in parallel on a stool 80. An X axis stage 83 is fitted to the movable parts of the Y axis stage 81 and the guide rails 82, and the X axis stage 83 is enabled to move in the direction of the Y axis. A chuck 84 is fixed to the X axis stage 83. The chuck 84 is connected to a pump (not shown) by a tube, and the sucking of air by the pump causes a substrate 85 to be attracted to the chuck 84. As the substrate 85 is not illustrated in detail in FIG. 8, its details will be shown in FIG. 9.

Supports 86 and 87 are fixed onto the stool 80, and bridges 88 and 89 are respectively fixed to the supports 86 and 87. The bridges 88 and 89 are fixed by a stay 92, and the supports 86 and 87 together with the bridges 88 and 89 maintain the strength of the structure. A head mount 90 is fixed between the bridges 88 and 89, and a head 91 is fixed to the head mount 90.

A sample solution is poured into the head 91, which is mounted on an ejecting apparatus. By operating the Y axis stage 81 and the X axis stage 83 to have the sample solution ejected from the head 91, the sample solution is ejected toward prescribed positions on the substrate 85.

FIG. 9 shows a section of peripheries of the substrate. The substrates 85 are arranged on the chuck 84. The head 91 is provided with a plurality of nozzles 93. Each of the nozzles 93 communicates with a sample solution inlet 94. A heater section (not shown) is provided in the vicinity of the nozzles 93. By filling the sample solution inlets 94 with a sample solution 95, the nozzles 93 are filled with the sample solution 95. By having a heater (not shown) to generate film boiling of the sample solution 95, the sample solution 95 is ejected from the nozzles 93 onto the substrates 85. The ejected sample solution 95 is arranged as spots 96 over the substrates 85.

FIG. 10 shows the arrangement of substrates 85 on the chuck 84. As shown in FIG. 10, the substrates 85 are arranged on the chuck 84, and the spots 96 are arranged on the substrates 85.

### SUMMARY OF THE INVENTION

As described above, in the conventional ejecting apparatus, a sample solution is ejected onto substrates, and probes in the sample solution are fixed on the substrates by having the substrates react with probes at room temperature.

In a spotting apparatus, too, a sample solution is spotted on substrates with pins, and DNA is fixed on the substrates by having the substrates react with probes in the sample solution at room temperature.

The reaction between substrates and probes in the sample solution may take 12 hours at room temperature, depending on the types of the substrates and the sample or the concentration of the sample. For this reason, in order to enhance the productivity of probe arrays by a solution applying apparatus, be it an ejecting apparatus or a spotting apparatus, it is required to reduce the reaction time between substrates and probes in the sample solution.

Generally, a chemical reaction can be accelerated by raising the temperature. Therefore, by controlling the temperature to a level where the reaction between substrates and probes in the sample solution is accelerated, the reaction time between the substrates and probes in the sample solution can be reduced.

Japanese Patent Application Laid-Open No. 2000-186880 discloses a method of manufacturing DNA chips by which the sample solution over substrates is dried, increased in viscosity and solidified by heating it with a laser beam, an infrared ray or an electromagnetic wave. The object is to prevent spots of the sample solution over the substrates from expanding in diameter by drying, solidifying and increasing the viscosity of the sample solution, and thereby uniformizing the spot diameters, which would result in qualitative improvement. In this case, depending on the combination of the sample solution and the substrates, drying the sample solution at high temperature in a short period of time might obstruct the reaction between the substrates and the sample substance in the sample solution.

At the same time, since samples used in probe arrays, such as DNA, are very expensive, it has been desired to raise the efficiency of reaction between the substrates and the sample substance to enable the concentration of the sample solution to be reduced.

The present invention is intended to provide an apparatus which permits shortening of the reaction time and enhancement of the reaction efficiency in a simple manner.

Thus, according to one aspect of the invention, there is provided an apparatus for applying onto a substrate a solution containing probes capable of specifically binding to a target substance, comprising: a holding member for holding the substrate; a solution applying section for applying the solution to the substrate; a sensor for monitoring a temperature of the substrate; and a temperature adjusting section for controlling the temperature of the substrate in accordance with an output of the sensor.

According to another aspect of the invention, there is provided an apparatus for applying onto a substrate a solution containing probes capable of specifically binding to a target substance, comprising: a solution applying section for applying the solution to the substrate; a sensor for monitoring a temperature of the solution in the solution applying section; and a temperature adjusting section for controlling the temperature of the solution in accordance with an output of the sensor.

The use of an apparatus according to the invention makes it possible to shorten the reaction time and enhance the reaction efficiency by raising the substrate holding temperature after applying a sample solution onto substrate. Therefore, the invention permits shortening of the reaction time and enhancement of the reaction efficiency in a simple manner.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 shows a perspective view of an ejecting apparatus, which is a first example of the present invention.

FIG. 2 shows a section of peripheries of the substrate of FIG. 1.

FIG. 3 shows the arrangement of substrates on the chuck in FIG. 1.

FIG. 4 is a flow chart of the first example of the invention.

FIG. 5 is a graph showing the results of measurement of the relationship between substrate holding temperature and fluorescence intensity in an experiment.

FIG. 6 shows a section of peripheries of substrates in a second example of the invention.

FIG. 7 is a flow chart of the second example of the invention.

FIG. 8 shows a perspective view of a conventional ejecting apparatus.

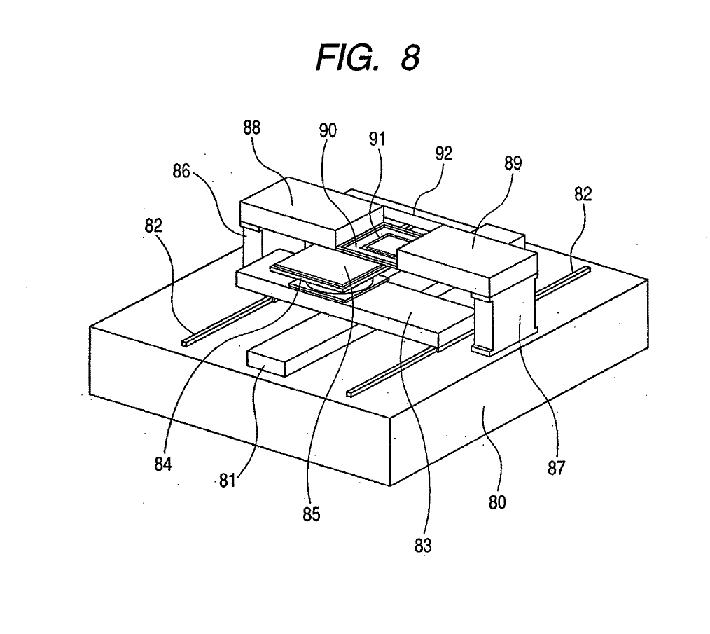

FIG. 9 shows a section of peripheries of the substrate of FIG. 8.

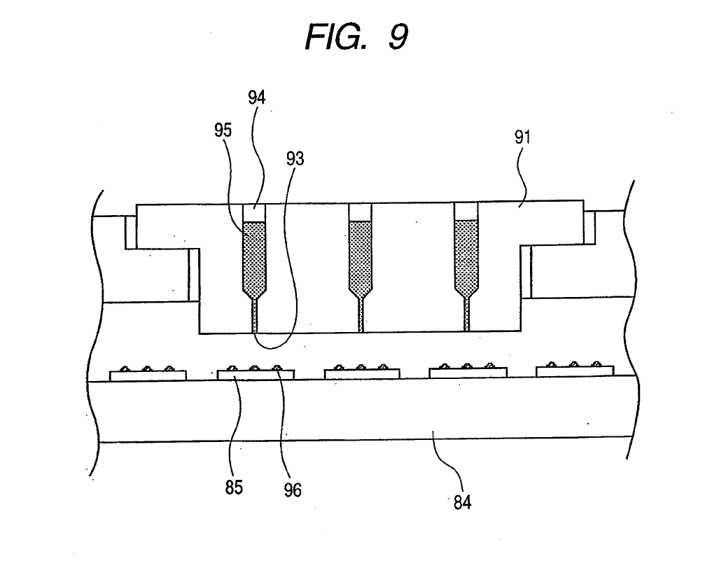

FIG. 10 shows the arrangement of substrates on the chuck.

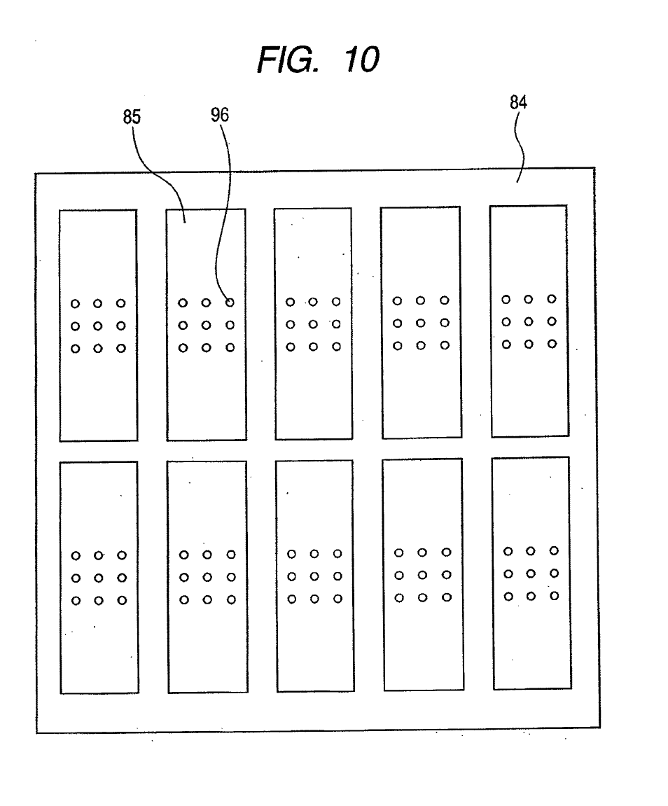

### DESCRIPTION OF THE EMBODIMENTS

Preferred embodiments of the present invention will now be described in detail in accordance with the accompanying drawings.

According to the present invention, an apparatus for applying onto substrates a sample solution containing probes capable of specifically binding to the target substance comprises holding members for holding the substrates; a solution applying section for applying a solution to the substrates; sensors for monitoring the temperature of the substrates; and a temperature adjusting section for controlling the temperature of the substrates in accordance with the outputs of the sensors.

As it is made possible in this way to keep the substrate temperature at a level where the reaction between the substrates and probes in the sample solution is accelerated and to shorten the reaction time, the productivity of probe arrays can be enhanced.

The temperature adjusting section for controlling the temperature of substrates performs this control by using the temperature monitored by the sensors. In this mode of implementing the invention, it is preferable to further provide a control section for feeding back a control temperature to the temperature adjusting section.

The presence of the solution applying section for applying the solution to substrates, the sensors for monitoring the solution temperature of the solution applying section and the temperature adjusting section for controlling the temperature of the solution makes it possible to keep the solution temperature in advance at a level where the reaction between the substrates and the probes in the sample solution is accelerated and to shorten the reaction time between the substrates and the probes in the sample solution, resulting in enhanced productivity of probe arrays.

The temperature adjusting section for controlling the solution temperature of the solution applying section performs this control by using the temperature monitored by the sensors. In this mode of implementing the invention, it is preferable to further provide a control section for feeding back a control temperature to the temperature adjusting section.

By controlling both the substrate temperature and the sample solution temperature, it is made possible to further shorten the reaction time between the substrates and the probes in the sample solution, resulting in correspondingly enhanced productivity of probe arrays.

The reaction accelerating temperature in this context differs with the combination of substrates and probes and/or other factors. For instance, where the sample is oligonucleotide formed by introducing a maleimide group onto a quartz substrate and a mercapto group is introduced at the terminal via a linker as disclosed in Japanese Patent Application Laid-Open No. H11-187900, the reactivity is remarkably high, sufficient reaction being achieved within 30 minutes even at room temperature, resulting in fixation of probes.

However, where the sample is oligonucleotide formed by introducing a formyl group onto a plastic substrate and an amino group is introduced at the terminal via a linker as disclosed in Japanese Patent Application Laid-Open No. 2003-161731, the reaction is carried on for 30 minutes at 37° C. or 60 minutes at 80° C.

Although the case cited here is a DNA chip formed by fixing a plurality of DNAs to a fixed substrate, there is no particular limitation regarding the substrate in this context if it involves no problem in fixing probes and using the resultant probe-fixed substrate for detecting or separating a target substance.

To cite a preferable form of micro-array by way of example, with the ease of target substance detection and versatility taken into account, a glass substrate or a plastic substrate is preferable, and a non-alkali glass substrate or quartz substrate containing no alkaline component would be particularly preferable.

The sample in this context is not limited to oligonucleotide or DNA which is a nucleotide fragment, but may as well be any probe capable of binding specifically to the target substance, including a biological macromolecule such as protein, peptide, antigen, antibody, PNA, RNA or sugar chain (which may be conjugated sugar chain). Of course, the probe may be either natural or non-natural.

While the relationship between reaction time and temperature relies on the combination of substrate and sample, physical properties including the concentration of the sample and the viscosity of the sample solution also have influences. Incidentally, the material of substrate, bonding mechanism and reaction-accelerating temperature are not limited to those stated above.

It is also possible to enhance the efficiency of reaction between the substrate and probes in the sample solution and thereby to reduce the concentration of probes in the sample solution by accelerating the reaction between the substrate and probes in the sample solution. As a result, the quantity of probes in the sample solution can be reduced with a corresponding saving in cost.

Known apparatuses for applying a sample solution onto substrates include, beside the above-described one which ejects a sample solution onto substrates from nozzles disposed in ejecting ports (ejecting apparatus), what spots a sample solution onto substrates by a pin method or otherwise (spotting apparatus).

Although the present invention does not limit itself to any particular method of applying a sample solution onto substrates, but a method of using ejecting ports each equipped with an electrothermal transducer for generating thermal energy in the ejection port to eject the liquid permits assured ejection of the liquid. Further by having nozzles disposed on the ejecting ports eject the liquid by utilizing film boiling caused by the thermal energy applied by the electrothermal transducers, the ejection of the liquid from the nozzles is further assured, and therefore this is a particularly suitable method.

Another applicable method of ejecting liquid is to use driving by piezo elements instead of heat.

Further by providing the holding members which hold the substrates with a plurality each of sensors monitoring the substrate temperature and of temperature adjusting sections, which control the temperature of the substrates, it is made possible to set a plurality of different substrate temperatures, and accordingly it is made possible to fabricate at the same time probe arrays in combination differing in accelerating temperature for the reaction between the substrate and probes in the sample solution.

It is also made possible to fabricate at the same time probe arrays whose temperature combination to accelerate the reaction between the substrate and probes in the sample solution differs from one substrate to another by providing on the holding members a sensor for monitoring the substrate temperature and a temperature adjusting section for controlling the temperature of the substrates for each substrate.

Also, by providing the solution applying section with a plurality each of sensors monitoring the solution temperature and of temperature adjusting sections for controlling the solution temperature, it is made possible to set a plurality of different solution temperatures, and accordingly it is made possible to fabricate at the same time probe arrays in combination differing in temperature to accelerate the reaction between the substrate and probes in the sample solution.

Further, by providing each solution applying section with a sensor for monitoring the solution temperature and a temperature adjusting section for controlling the solution temperature, it is made possible to fabricate at the same time probe arrays whose temperature combination to accelerate the reaction between the substrate and probes in the sample solution differs from one substrate to another.

As described above, when the reaction is to be accelerated, heating facilitates the evaporation of the liquid droplets that are applied. Since drying of the liquid droplets would obstruct the reaction between the substrates and the probes, it is preferable to prevent evaporation by providing a humidifying function. The configuration for this purpose may include a humidifying chamber.

The present invention also provides a configuration which is suitable for the manufacture of a large number of arrays. If, for instance, probes are applied to a second substrate after the completion of probe application to a first substrate, a first array can be subjected to a heated reaction while probes are being applied to a second array. Therefore, probe application and heated reaction can be carried out at the same time within the same apparatus, and the time required for array manufacturing per unit can be reduced by successively taking out the arrays having undergone the heated reaction.

Moreover, by disposing the control section elsewhere than on the holding members of the apparatus, the weight of the holding members can be reduced, and the power required for driving the stage to move the holding members can be saved correspondingly.

Furthermore, where a temperature adjusting section for controlling the temperature of the substrates and another temperature adjusting section for controlling the solution temperature are to be provided, a common control section may control both.

Examples of the present invention will be described below in specific terms.

### Example 1

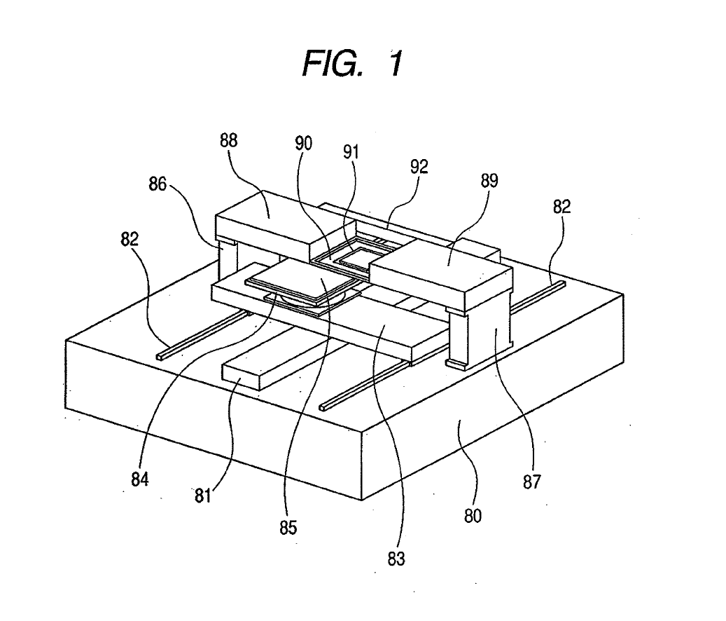

A first example of the invention will be described below with reference to FIGS. 1, 2, 3, 4 and 5.

FIG. 1 shows a perspective view of an ejecting apparatus (bubble jet type). A Y axis stage 81 and guide rails 82 are fixed in parallel onto a stool 80. An X axis stage 83 is fitted to the movable parts of the Y axis stage 81 and the guide rails 82, and the X axis stage 83 is enabled to move toward the Y axis. A chuck 84 is fixed to the movable part of the X axis stage 83. The chuck 84 is connected to a pump (not shown) by a tube, and the sucking of air by the pump causes a substrate 85 to be attracted to the chuck 84. The chuck 84 is provided with a temperature sensor section, a heating/cooling section and a feedback control section (not shown). The feedback control section may be disposed either on the chuck 84 or on the ejecting apparatus elsewhere than on the chuck 84. It is advisable, however, to keep the feedback control section immune from the thermal effect of the heating/cooling section by arranging it at a distance from the heating/cooling section or otherwise.

Supports 86 and 87 are fixed onto the stool 80, and bridges 88 and 89 are respectively fitted onto the supports 86 and 87. The bridges 88 and 89 are fixed by a stay 92, and the supports 86 and 87 together with the bridges 88 and 89 maintain the strength of the structure. A head mount 90 is fixed between the bridges 88 and 89, and a head 91 is fixed to the head mount 90.

A sample solution is poured into the head 91, which is mounted on an ejecting apparatus. By operating the Y axis stage 81 and the X axis stage 83 to have the sample solution ejected from the head 91, the sample solution is ejected toward prescribed positions on the substrate 85. To prevent the sample solution on the substrate 85 from drying, a cover may be arranged over the substrate 85 after the ejection of the sample solution over the substrate 85. Alternatively, the surroundings of the sample solution on the substrate 85 may be humidified with a humidifier (not shown).

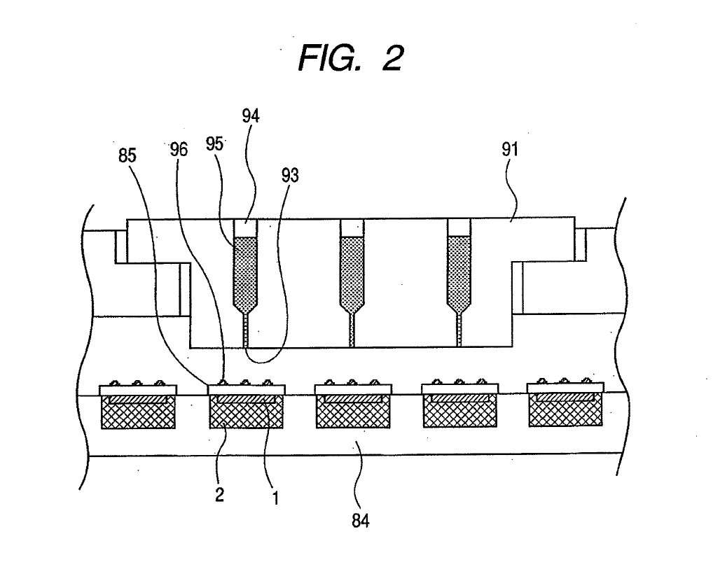

FIG. 2 shows a section of peripheries of the substrates. The substrates 85 are arranged on the chuck 84. The head 91 is provided with a plurality of nozzles 93. Each of the nozzles 93 communicates with a sample solution inlet 94. A heater section (not shown) is provided in the vicinity of the nozzles 93. By filling the sample solution inlets 94 with a sample solution 95, the nozzles 93 are filled with the sample solution 95. By having a heater (not shown) to generate film boiling of the sample solution 95, the sample solution 95 is ejected from the nozzles 93 onto the substrates 85. The ejected sample solution 95 is arranged as spots 96 over the substrates 85. The configuration may as well be such that piezo elements are disposed in the vicinities of the nozzles 93, and the sample solution 95 is ejected onto the substrates 85 from the nozzles 93 by driving the piezo elements.

Temperature sensor sections 1 are disposed underneath the substrates 85 in positions matching the spots 96. Around the temperature sensor sections 1, heating/cooling sections 2 are provided. The temperature sensor sections 1 and the heating/cooling sections 2 are electrically connected to feedback control sections (not shown). One each of these temperature sensor sections 1, heating/cooling sections 2 and feedback control sections (not shown) may be provided for each individual substrate or each group of substrates.

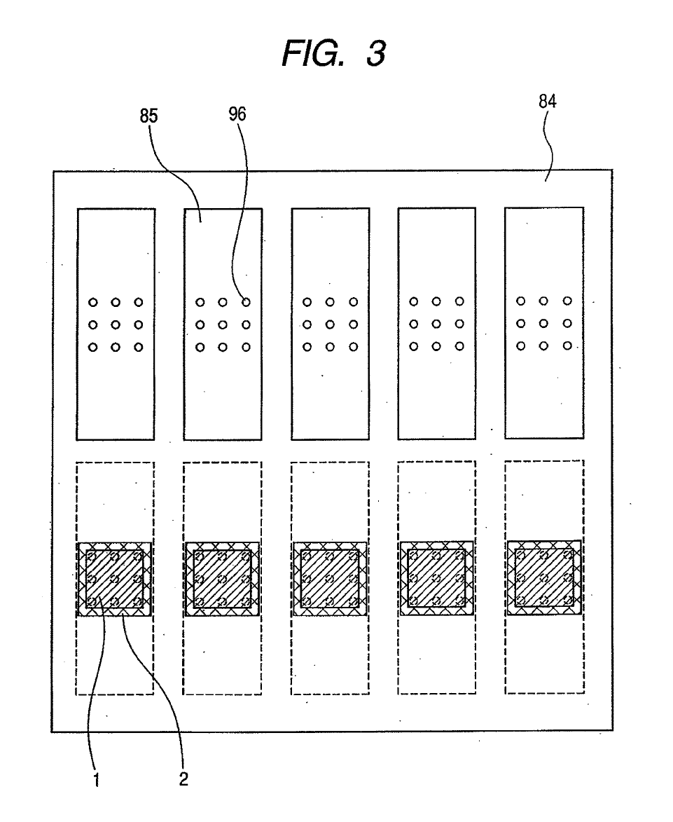

FIG. 3 shows the arrangement of the substrates 85 on the chuck 84. As shown in FIG. 3, the substrates 85 are arranged on the chuck 84, and the spots 96 are arranged on the substrates 85. Also, the temperature sensor sections 1 and the heating/cooling sections 2 are arranged on the chuck 84. To highlight the positional relationships among the temperature sensor sections 1, the heating/cooling sections 2, the substrates 85 and the spots 96, some of the substrates 85 and the spots 96 are represented in broken lines.

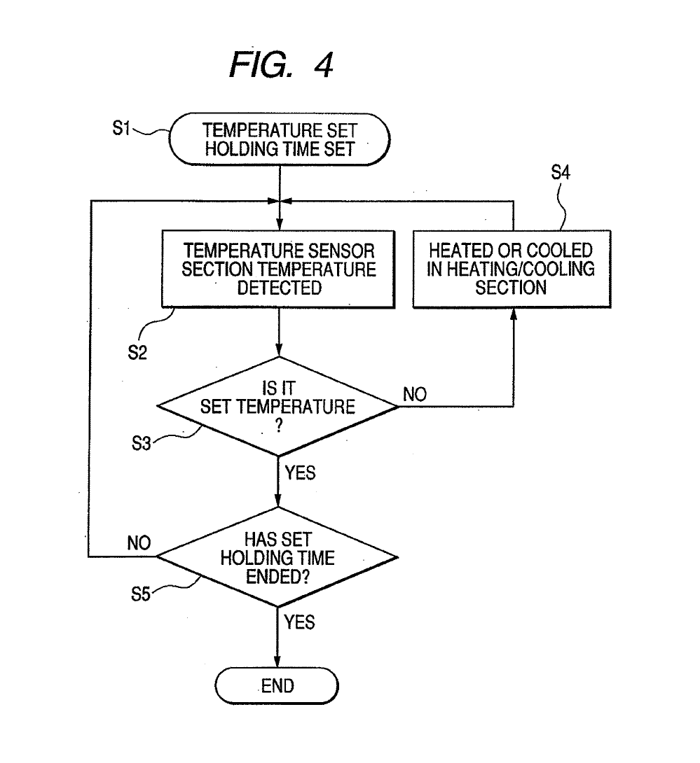

FIG. 4 is a flow chart of this example. First at step S1, the temperature to accelerate the reaction between the substrates 85 and the spots 96 and the length of time required for the reaction between the substrates 85 and the spots 96 are set. At step S2, the substrate temperature is measured by the temperature sensor section 1. At step S3, the feedback control section determines whether or not the measured temperature is equal to the set temperature. If it is, the flow will proceed to step S5. If it is not, the flow will proceed to step S4, and the heating/cooling sections 2 heat or cool the substrates 85, followed by a return to step S2. At step S5, it is determined whether or not the set holding time has ended. If the set holding time has ended, the flow ends. If it has not, the flow will return to step S2.

The setting of the substrate temperature to the prescribed level may either precede or follow the ejection of the sample solution from the ejecting apparatus to the substrates. By setting the substrate temperature to the prescribed level before the ejection of the sample solution from the ejecting apparatus to the substrates, the time taken by the sufficient progress of the reaction between substrates and DNA in the sample solution after the ejection can be shortened.

However, as the spotting speed of a spotting apparatus which uses pins for the application of the sample solution is generally slower than the ejecting apparatus, the duration of heating would widely differ from the first applied liquid droplet and the last applied one. Unlike that, the ink jet type ejecting apparatus embodying the invention applies the sample solution in a shorter period of time, and accordingly the difference in heating duration is much smaller, which constitutes an advantage.

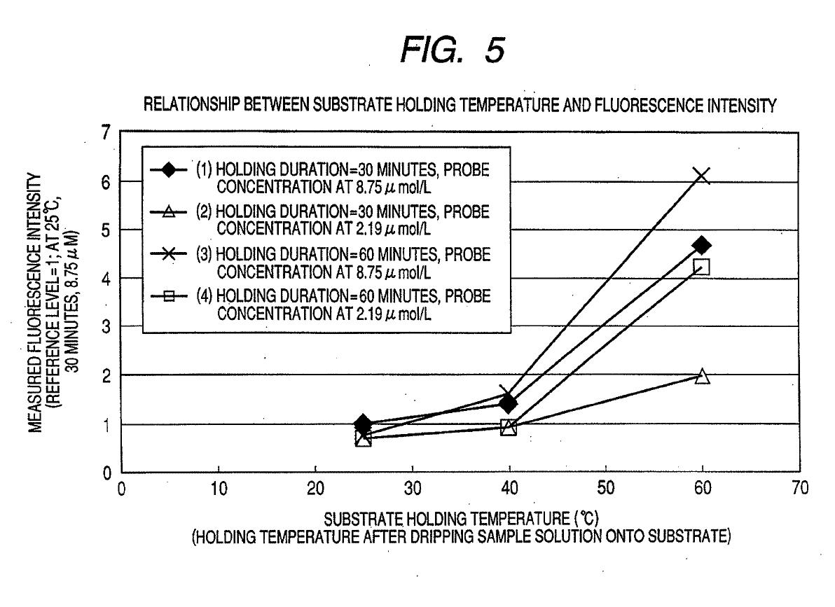

FIG. 5 is a graph showing the results of measurement of the relationship between substrate holding temperature and fluorescence intensity in an experiment.

The substrates used were Full Moon Biosystems' PXP-M25 (PowerMatrix Slides, for NH₂-modified oligos, non-barcode) products, which are oligonucleotide substrates for fixed use to which an amino group is introduced. According to the printing protocol released by this substrate manufacturer, the substrates are supposed to be allowed to stand for 10 to 12 hours in an environment of 65 to 75% in post-spotting humidity. With this example, the probes were fixed and a hybridization reaction was let take place in the following procedure to measure fluorescence intensity.

(1) Oligonucleotide of SEQ ID No. 1, into which an amino group is introduced at the terminal via a linker was synthesized with an automatic synthesizer.

(2) Oligonucleotide of SEQ ID No. 1 was so dissolved in an aqueous solution containing 7.5 wt % of glycerin, 7.5 wt % of thiodiglycol and 1 wt % of acetylene alcohol (a product of Kawaken Fine Chemicals Co., Ltd.: Acetylenol E100 in trade name) to obtain sample solutions of 8.75 μmol/L and 2.19 μmol/L.

5′H₂N—(CH₂)₆—O—PO₂—O-ACTGGCCGTCGTTTTACA3′ (SEQ ID No. 1)

(3) These sample solutions were applied to the aforementioned substrates.

(4) The substrate temperature was held at its set levels (25° C., 40° C. and 60° C.). It was held for two different durations, 30 minutes and 60 minutes.

(5) The substrates were washed with a buffer solution of 1 mol/L NaCl and 50 mmol/L phosphoric acid (pH 7.0).

(6) Bovine serum albumin was dissolved in a buffer solution of the 1 mol/L NaCl and 50 mmol/L phosphoric acid (pH 7.0) to a concentration of 1.0 wt %, and the substrates prepared by the above-described method were kept immersed in this solution for 1 hour at room temperature to subject them to a blocking reaction.

(7) Oligonucleotide (SEQ ID No. 2) labeled with Cy3 bonded to the 5′ terminus of a DNA fragment having a nucleotide sequence complementary to the probe of SEQ ID No. 1 was synthesized, and dissolved in a buffer solution of 1 mol/L NaCl and 50 mmol/L phosphoric acid (pH 7.0) to a concentration of 50 mmol/L. The blocked substrates were immersed in the solution containing labeled DNA fragments, and allowed to stand at 45° C. for two hours. After that, unreacted DNA fragments were washed with a buffer solution of 1 mol/L NaCl and 50 mmol/L phosphoric acid (pH 7.0) and further with pure water.

(8) The hybridized substrates were subjected to fluorescence measurement of 532 nm with a fluorescent scanner (a product of Axon Instruments, Inc.: GenePix4000B in trade name). The measurement at PMT 600 V with a 100% laser power gave the result shown in FIG. 5.

As is seen from the graph of FIG. 5, raising the substrate holding temperature resulted in a rise in fluorescence intensity. This indicates that raising the substrate holding temperature serves to increase the quantity of probes bonded to the substrates. (In the graph, the fluorescence intensity measured at a holding temperature of 25° C., a holding duration of 30 minutes and a probe concentration of 8.75 μmol/L is supposed to be a reference level 1.)

The fluorescence intensity at 60° C., stated in the graph as [4] (holding duration=60 minutes, probe concentration=2.19 μmol/L) is higher than the fluorescence intensity at 40° C. in [3] of the same graph (holding duration=60 minutes, probe concentration=t 8.75 μmol/L). This demonstrates that it is possible to bond more probes to substrates even from a sample solution lower in probe concentration than from a sample solution higher in probe concentration by raising the substrate holding temperature and thereby to enhance the reaction efficiency between the substrates and the probes.

### Example 2

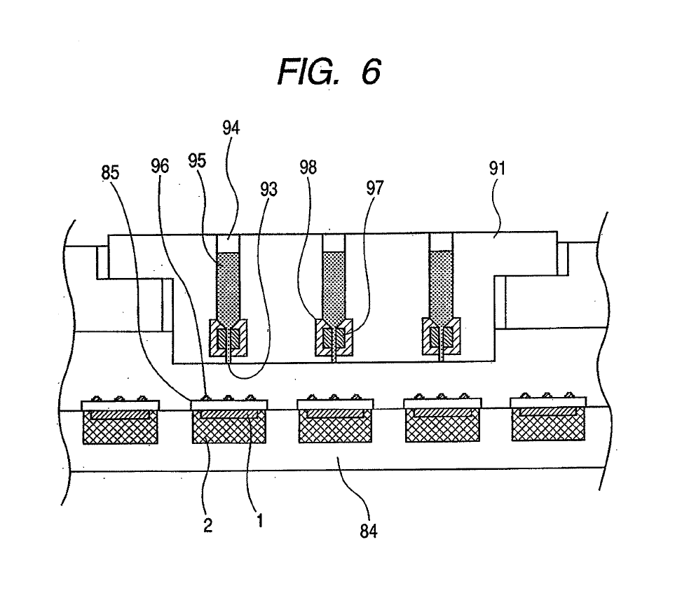

A second example of the present invention will be described below with reference to FIG. 6. This example differs from Example 1 only in head configuration. Therefore, description of other constituent elements will be dispensed with.

FIG. 6 shows a section of peripheries of substrates. Substrates 85 are arranged on a chuck 84. A head 91 is provided with a plurality of nozzles 93. Each of the nozzles 93 communicates with a sample solution inlet 94. In the vicinities of the nozzles 93, a heater section (not shown) is disposed. By filling the sample solution inlets 94 with a sample solution 95, the nozzles 93 are filled with the sample solution 95. By having a heater (not shown) to generate film boiling of the sample solution 95, the sample solution 95 is ejected from the nozzles 93 onto the substrates 85. The ejected sample solution 95 is arranged as spots 96 over the substrates 85. The configuration may as well be such that piezo elements are disposed in the vicinities of the nozzles 93, and the sample solution 95 is ejected onto the substrates 85 from the nozzles 93 by driving the piezo elements.

Solution temperature sensor sections 97 are also disposed in the vicinities of the nozzles 93. A solution heating/cooling section 98 is provided around each of the solution temperature sensor sections 97. The solution temperature sensor sections 97 and the solution heating/cooling sections 98 are electrically connected to solution temperature feedback control sections (not shown). One each of these solution temperature sensor sections 97, the solution heating/cooling sections 98 and the unshown solution temperature feedback control sections may be provided either for each individual nozzle or each group of nozzles.

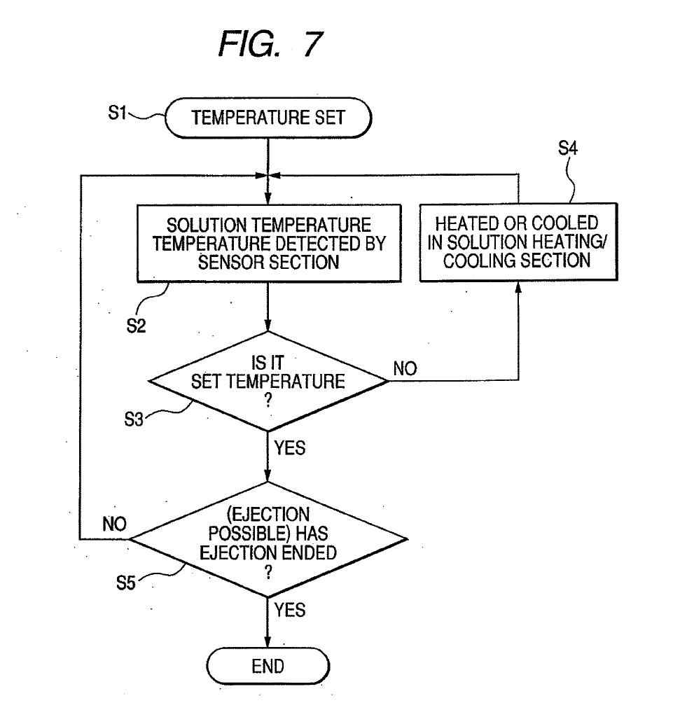

FIG. 7 is a flow chart of this example. First at step S1, the temperature to accelerate the reaction between the substrates 85 and the spots 96 is set. At step S2, the solution temperature sensor sections 97 measure the temperature of the sample solution 95 in the vicinities of the nozzles 93. At step S3, the solution temperature feedback control sections determine whether or not the measured temperature is equal to the set temperature. If it is, the flow will proceed to step S5 to make ejection possible. If it is not, the flow will proceed to step S4, and the solution heating/cooling sections 98 heat or cool the sample solution 95 in the vicinities of the nozzles 93, followed by a return to step S2. At step S5, it is determined whether or not the ejection has ended. If it has, the flow is ended.

In this example, further the substrate temperature may be controlled as described with reference to Example 1.

### Other Embodiments

A solution applying apparatus according to the invention can also be configured as part of a probe carrier manufacturing system. In this case, a system to qualify the substrate surface with a functional group for fixing nucleic acid and a system to wash the substrates to which a solution has been applied by the applying apparatus according to the invention may be additionally provided for consecutive accomplishment of the sequence of processing.

These systems may be arranged either on a line or as a sheet-fed type. The substrate holding members according to the invention may as well be used in common among the different steps of processing.

The present invention is not limited to the above examples and various changes and modifications can be made within the spirit and scope of the present invention. Therefore to apprise the public of the scope of the present invention, the following claims are made.

This application claims the benefit of Japanese Patent Application No. 2005-268711, filed Sep. 15, 2005, which is hereby incorporated by reference herein in its entirety.

1-19. (canceled)

20. A manufacturing method of a plurality of probe arrays comprising probes each capable of specifically binding to a target substance, the probes being fixed onto surfaces of a plurality of substrates through a reaction between the probes and the substrates, comprising the steps of:
holding the plurality of substrates arranged in order on a surface of a holding member,
applying a plurality of solutions as a droplet containing at least one probe onto the surfaces of the substrates, and
keeping temperatures of the substrates at a level such that a reaction between the substrates and the at least one probe in the solution is accelerated,
wherein each of the temperatures of the substrates on the holding member is kept at the level by monitoring the temperatures and feeding back the monitored temperatures of the individual substrates during the step of applying the solutions, and
wherein the substrates on the surface of the holding member are kept in a humidified atmosphere during the step of keeping temperatures.

21. The method according to claim 20, wherein the holding member includes a plurality of temperature sensors, each of which monitors the temperature of the corresponding substrate.

22. The method according to claim 20, wherein the holding member includes a plurality of heating/cooling means, each of which heats or cools the corresponding substrate.

23. The method according to claim 20, wherein the plurality of solutions are applied by a liquid ejection device having:
a plurality of nozzles, each nozzle including a solution containing at least one probe to be spotted on the surfaces of the substrates;
a plurality of temperature sensors, each sensor monitoring a temperature of the solution in the corresponding nozzle, and
a plurality of heating/cooling means, each heating/cooling means heating or cooling the solution in the corresponding nozzle.

24. The method according to claim 20, wherein the plurality of solutions are applied and spotted onto the surfaces of the substrates by an ink jet system.

25. The method according to claim 24, wherein the ink jet system ejects each of the solutions by an electrothermal transducer generating thermal energy.

26. The method according to claim 24, wherein the ink jet system ejects each of the solutions by a piezo element.

27. The method according to claim 20, further comprising the steps of:
modifying the surfaces of the substrates with a functional group; and
washing the surfaces of the substrates.
